(19) United States
(12) Patent Application Publication
(10) Pub. No.: US 2026/0153217 A1
(43) Pub. Date: Jun. 4, 2026

(54) PCB VEHICLE FRONT ROAD LIGHTING LAMP WITH LED ANGLE

(71) Applicant: SERDAR PLASTIK SANAYI VE TICARET A.S, Sincan/Ankara (TR)

(72) Inventor: Mustafa Serdar TUTEK, Sincan/Ankara (TR)

(73) Assignee: SERDAR PLASTIK SANAYI VE TICARET A.S, Sincan/Ankara (TR)

(21) Appl. No.: 18/706,755

(22) PCT Filed: Nov. 4, 2022
(86) PCT No.: PCT/TR2022/051244

§ 371 Date: May 2, 2024

(30) Foreign Application Priority Data
Nov. 4, 2021 (TR) 2021/017178

(51) Int. Cl. F21S 45/50; F21S 41/147; F21S 41/19; F21S 41/32; F21S 45/33; F21S 45/47

(52) U.S. Cl. CPC F21S 45/50; F21S 41/147; F21S 41/192; F21S 41/321; F21S 45/33; F21S 45/47

(57) ABSTRACT

The subject of the present invention is all-LED front road lighting lamp that is made of completely recyclable thermoplastic material, that has high and low beam lighting and position/aesthetic lamp features, that has a wireless self-connector, that has a safe and powerful position adjustment system consisting of two parts; and it is a product that incorporates a specially designed sealing gasket that provides sealing from every point, (Thermoplastic Vulcanizate—TPV) and socket insertion area. In addition, it has an anti-condensation protective plug to prevent condensation; due to its structure, by the positioning of an off-axis hole, even if there is snow, dirt, etc. on the lamp, the system can prevent condensation by continuing the ventilation and by making the ventilation from the side part and by means of its federated structure inside.

The present invention relates to vehicle exterior lighting in general and particularly, vehicle headlights incorporating an LED light source. The invention relates to an all-LED front road lighting lamp that can be used in all vehicles suitable for installation in automobiles, trucks, buses, minibuses, motorcycles, off-road vehicles, agricultural vehicles, construction machinery, defense vehicles, transportation, aviation, and similar industries, that is produced from 100% recycled thermoplastic material, that has low energy consumption with LED, is environmentally friendly and long-lasting, that provides high lighting power with its advanced optical design and high sealing with its special sealing design, that has high, low beam lighting and position/aesthetic lamp features at night and in dark areas, that has a wireless self-connector, and that has a two-part safe and powerful position adjustment system.

All of the light coming out of the LEDs is reflected to the reflector and from there to the road by placing the PCB at an angle of 30° with respect to the parabolic reflector. Thus, it is characterized by minimizing light loss and providing maximum lighting efficiency.

It is characterized by an all-LED headlight system, comprising a light distribution unit with position/aesthetic lamp capability at the top and a variable light distribution unit with low or high beam at the bottom.

### TECHNICAL FIELD OF THE INVENTION

The present invention relates to All-LED car front lighting lamp (headlight) with wireless self-connector, that has two-part safe and powerful position adjustment system, and that can be used in all vehicles suitable for assembly in automobiles, trucks, buses, minibuses, motorcycles, off-road vehicles, agricultural vehicles, construction machinery, defense vehicles, transportation, aviation and similar industries.

### PRIOR ART

In all vehicles, front road lighting lamps (headlights) are of great importance as a warning as well as providing lighting. The headlights are made to be easily noticed by other vehicles and to illuminate your front especially when driving at night.

According to state of the art, a thermoset gasket or PU is poured in order to provide sealing in the connector area. In the product of the present invention, full sealing is provided by means of a thermoplastic 100% recyclable elastomer material for maximum sealing in the connector area.

In the headlight design, which is one of the difficulties in vehicle exterior lighting design, it creates a desired beam pattern in accordance with the purpose. This is especially valid in motor vehicle applications, which are required by the regulations of the states. Conventional vehicle headlights comprise optical components such as a light source, lenses, and reflectors to collect and shape the light emitted by the light source, as well as reflect the resulting beam pattern beyond the vehicle.

### DETAILED DESCRIPTION OF THE INVENTION

The present invention particularly relates to LED light sources that can be used in a headlight to generate the light distribution pattern of an incandescent light. Again, more particularly, the present invention relates to LED light sources that can be used as automotive headlight illumination. LEDs are now used in a variety of lighting applications for both efficiency and durability.

The invention, which is the subject of the patent, is a lamp having a body (7) made of thermally conductive plastic material and relates to a road lighting vehicle headlight system and more particularly a short, long path lighting and position/aesthetic lamp vehicle headlight system capable of providing various light distribution patterns. The light distribution model is characterized by being a vehicle headlight that can be used as short and long to indicate the presence of an oncoming vehicle or objects in high visibility relative to the surroundings, such as a forward vehicle, etc.

### BRIEF DESCRIPTION OF THE FIGURES

FIG. 1 illustrates the exploded view of the PCB vehicle front road lighting lamp with LED angle.

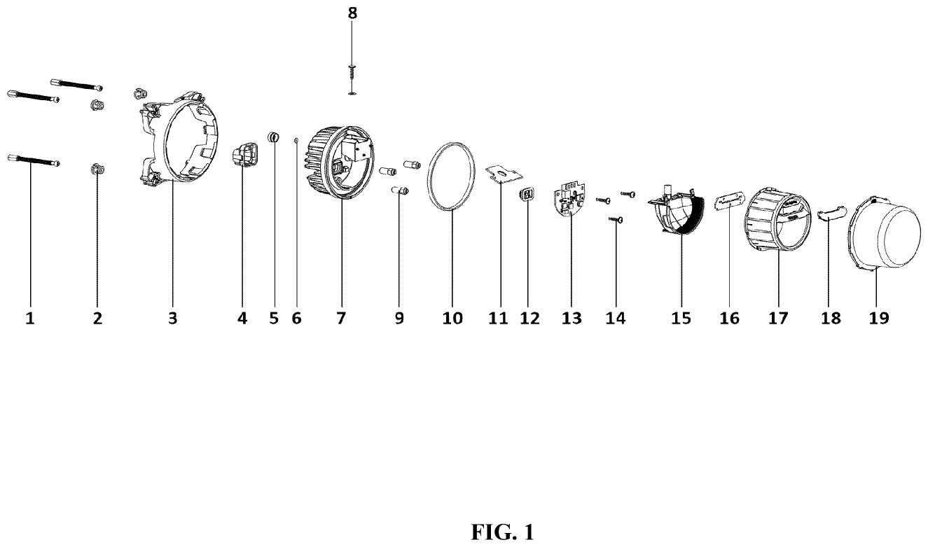

FIG. 2 illustrates the front view of the PCB vehicle front road lighting lamp with LED angle.

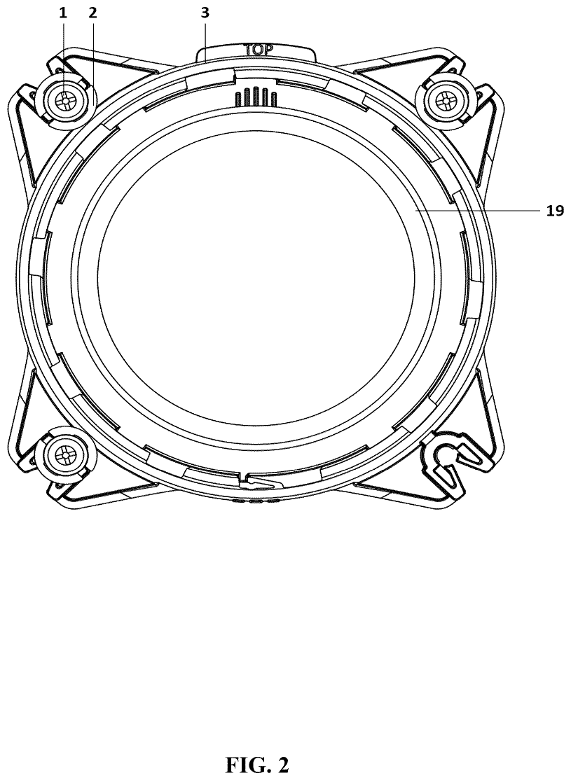

FIG. 3 illustrates the rear view of the PCB vehicle front road lighting lamp with LED angle.

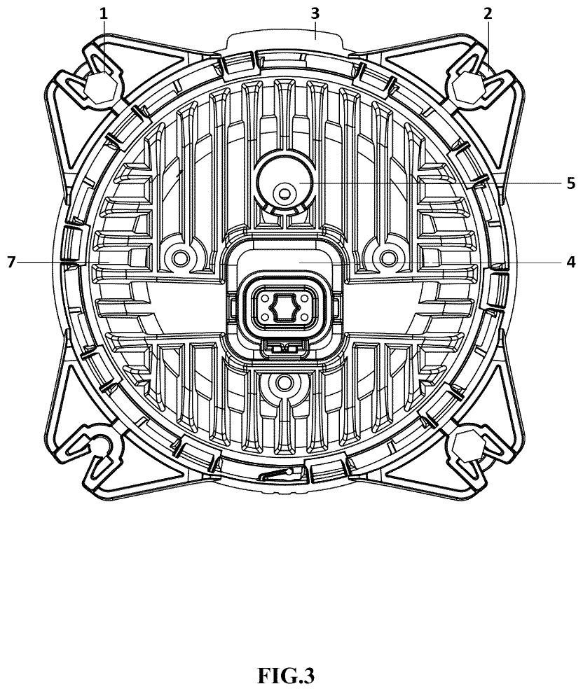

FIG. 4 illustrates the left-side view of the PCB vehicle front road lighting lamp with LED angle.

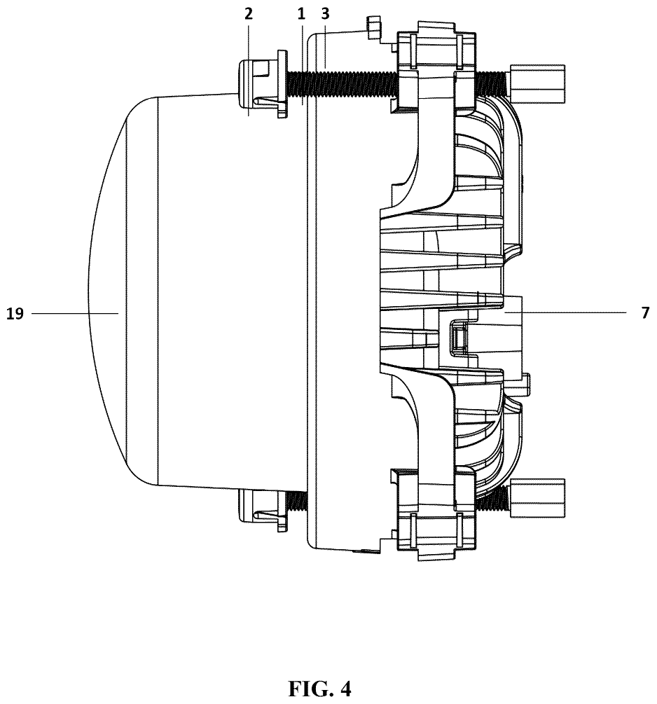

FIG. 5 illustrates the right-side view of the PCB vehicle front road lighting lamp with LED angle.

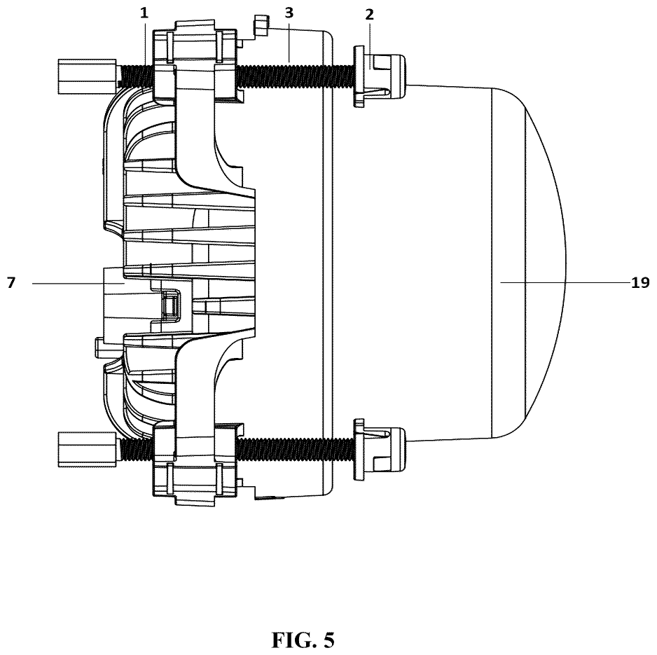

FIG. 6 illustrates the sectional view of the PCB vehicle front road lighting lamp with LED angle.

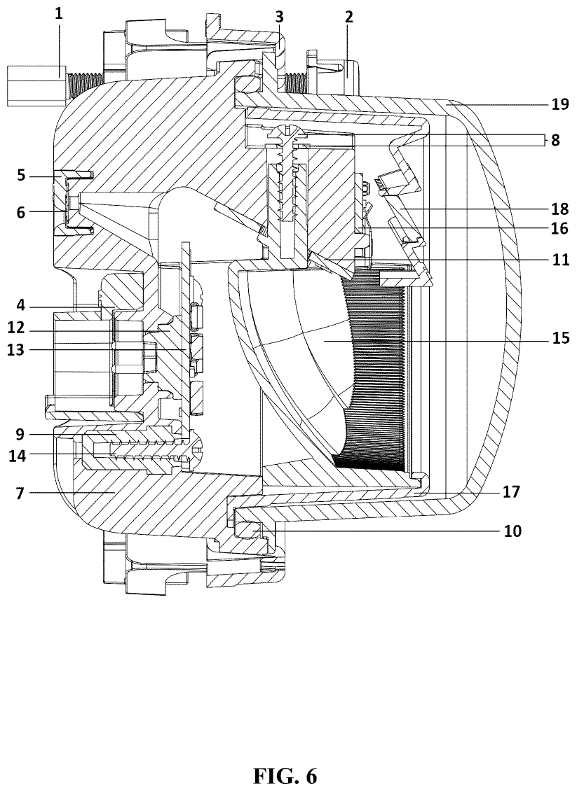

### LIST OF REFERENCES

1—Adjusting Bolt of the PCB Vehicle Front Road Lighting Lamp with LED Angle
2—Adjusting Bearing of the PCB Vehicle Front Road Lighting Lamp with LED Angle
3—Frame of the PCB Vehicle Front Road Lighting Lamp with LED Angle
4—Connector Lid of the PCB Vehicle Front Road Lighting Lamp with LED Angle
5—Ventilation Anti-Condensation Plug of the PCB Vehicle Front Road Lighting Lamp with LED Angle
6—Ventilation Band of the PCB Vehicle Front Road Lighting Lamp with LED Angle
7—Ventilation Body of the PCB Vehicle Front Road Lighting Lamp with LED Angle
8—Reflective Screw and Washer of the PCB Vehicle Front Road Lighting Lamp with LED Angle
9—Ventilation Plastic Insert of the PCB Vehicle Front Road Lighting Lamp with LED Angle
10—Ventilation Convex Sectional Gasket of the PCB Vehicle Front Road Lighting Lamp with LED Angle
11—Ventilation Angle PCB of the PCB Vehicle Front Road Lighting Lamp with LED Angle
12—Ventilation Terminal Isolator of the PCB Vehicle Front Road Lighting Lamp with LED Angle
13—Ventilation Driver PCB of the PCB Vehicle Front Road Lighting Lamp with LED Angle
14—Ventilation PCB Screw of the PCB Vehicle Front Road Lighting Lamp with LED Angle
15—Ventilation Reflector of the PCB Vehicle Front Road Lighting Lamp with LED Angle
16—ventilation Position PCB of the PCB Vehicle Front Road Lighting Lamp with LED Angle
17—Ventilation Bezel of the PCB Vehicle Front Road Lighting Lamp with LED Angle
18—Ventilation Frosted Lens of the PCB Vehicle Front Road Lighting Lamp with LED Angle
19—Ventilation Lens of the PCB Vehicle Front Road Lighting Lamp with LED Angle

The subject of the present invention is all-LED front road lighting lamp that is made of completely recyclable thermoplastic material, that has high and low beam lighting and position/aesthetic lamp features, that has a wireless self-connector, that has a safe and powerful position adjustment system consisting of two parts; and it is a product that incorporates a specially designed sealing gasket (thermoplastic material Vulcanizat—TPV) and a socket insertion area, which provides sealing from every point in order to overcome the sealing problems encountered in existing lamps. It is characterized by being lighter than the models produced with light aluminum and similar raw materials by means of its one-piece conductive body (7) structure consisting of thermally conductive material with high conductivity.

By means of its structure connected to the wireless direct socket on the body (7), breaking of the cables due to external factors is also prevented, unlike the state of the art. In addition, it has an anti-condensation protective plug (5) to prevent condensation; due to its structure, by the positioning of an off-axis hole, even if there is snow, dirt, etc. on the lamp, the system can prevent condensation by continuing the ventilation and by making the ventilation (6) from the side part and by means of its federated structure inside. It is also characterized by the fact that it transfers the heat out quickly since it has a body (7) made of thermally conductive plastic material.

By placing the PCB (11) at an angle of 30° with respect to the parabolic reflector (16), all of the light coming out of the LEDs is reflected to the reflector (15) and from there to the road. Thus, it is characterized by minimizing light loss and providing maximum lighting efficiency.

It is characterized by positioning the PCB (11) at a 30° opposite angle (19) with respect to the reflector (15) in order to ensure that the 60° (18) light emanating from the LEDs on the PCB (11) reaches the entire area on the surface of the parabolic reflector (15) and illuminates the targeted area at maximum level. By placing the PCB (11) at an angle with respect to the parabolic reflector (15), all of the light coming out of the LEDs is reflected to the reflector and from there to the road. Thus, it is characterized by minimizing light loss and providing maximum lighting efficiency.

The subject of the present invention is characterized by all-LED front road lighting lamp that is made of completely recyclable thermoplastic material, that has high and low beam lighting and position/aesthetic lamp features, that has a wireless self-connector (4), that has a safe and powerful position adjustment system consisting of two parts.

One of the most difficult lighting applications is automotive headlight lighting. There are many reasons to use LEDs in headlights due to their long life and durability. Good brightness is required, but LED is less luminous than tungsten lamps; therefore, it is necessary to use more LEDs to provide the total number of lumens required. Sufficient illumination can be obtained by combining a large number of LEDs on a certain axis, however, dispersed light sources are difficult to integrate optically, and advanced automotive lighting requires perfect beam direction. In this case, an LED headlight system with sufficient lumens and a good beam structure is required. With its advanced optical design, it is possible to reach the headlight function by spreading the LEDs over a wide area. In this process, a one-piece body made of thermally conductive polymer material is beneficial for this problem to solve the problem of overheating and accelerate heat transfer.

In the state of the art, it is characterized by the fact that the position adjustment mechanisms, which consist of more parts, fulfill their task with the position (16) adjustment system, which is shaped in a safe and robust way, consisting of two parts.

It is characterized by being lighter than the models produced from aluminum and similar raw materials and being able to transfer heat quickly by means of a one-piece body (7) structure made of Thermal Conductive Polymer material.

In advanced optical design, the PCB is placed at an angle of 30° to the parabolic reflector, and most of the LED light is reflected onto the optical surface for reflecting the LED PCB (11) to the reflector (15) so that it is angled relative to the reflector (15) and to be able to drop more light from one or more LED units to the desired region, and to direct the lights coming out of the LED to the area to be illuminated, with the parabolic reflector (16) that transmits the light in the maximum way with the axis of the LED PCB (11) transversely aligned surfaces. The body part, which is made of thermally conductive polymer that provides this, is characterized by being a single piece that can be molded in one time, that is rustproof, and lightweight.

One-piece, highly conductive, thermally conductive polymer body, provides minimum cost with minimum number of parts and maximum centering with minimum misalignment that can be foreseen during product grouping phase.

In order to direct the lights coming out of the LED to the area to be illuminated, most of the LED light is reflected onto the optical surface. Another feature of the body (7) part, which is made of conductive polymer that provides this, is that it can be molded at once.

In addition, it has an anti-condensation protective plug (5) to prevent condensation; due to its structure, by the positioning of an off-axis hole, even if there is snow, dirt, etc. on the lamp, the system is characterized by preventing condensation by continuing the ventilation and by making the ventilation (6) from the side part and by means of its federated structure (6) inside.

It is characterized by there is no parting line in the sealing area in any part of the lamp between the lens and the body, including the convex gasket (10), which can be molded and produced from one piece, with a special design of sealing, and a barrel-like cross section. and, by means of this feature, providing maximum impermeability.

Another feature of the invention is that it contains 30 LED PCB (16) placed in a reverse angled position in order to collect a large part of the light coming out of the LED and transmit it to the road.

Also thermoplastic terminal insulator (12) for maximum sealing in the connector (4) area provides sealing by being a 100% recyclable elastomer material.

It is characterized by the positioning of the PCB at 30 opposite angles to the parabolic reflector in order to reach the entire area on the surface of the 60 parabolic reflectors (15) coming out of the LEDs on the PCB (16) and to illuminate the targeted area at maximum level.

By placing the PCB (11) at an angle with respect to the parabolic reflector (15), all of the light emanating from the LEDs is reflected to the reflector (15) and from there to the road. In this way, maximum lighting efficiency can be achieved by minimizing light loss.

It can fulfill the task of the position adjustment mechanisms, which consist of more parts in known techniques, with the position adjustment system that is shaped in a safe and robust way, which consists of two parts, and by means of the structure (9) with wireless direct socket connection on the body (7), the breaking of the cables due to external factors is also prevented.

What is claimed is:

1. A front lighting lamp with LED, characterized in that, it is a product that contains a special sealing gasket (thermoplastic Vulcanizate—TPV) and a socket insertion area that provides sealing from every point with a wireless self-connector.

2. A front lighting lamp with LED according to claim 1, characterized in that it is lighter than the models produced with light aluminum and similar raw materials by means of its one-piece conductive body (7) structure consisting of thermally conductive material with high conductivity.

3. A front lighting lamp with LED according to claim 1, characterized in that, it can transfer heat similarly faster than models produced from aluminum and similar highly conductive raw materials by means of the conductive body (7) structure consisting of thermally conductive polymer material with high conductivity.

4. A front lighting lamp with LED according to claim 1, characterized in that most of the LED light is reflected onto the optical surface in order to direct the lights coming out of the LED to the area to be illuminated by means of its body (7) consisting of thermally conductive polymer material with high conductivity, and the other feature of the body (7) part, which is made of conductive polymer that provides this, is that it can be molded at one time.

5. A front lighting lamp with LED according to claim 1, characterized in that; It contains a convex sectional gasket (10), that can be molded and produced from one piece once, that has a specially designed sealing, and that has a barrel-like cross section, and there is no parting-line in the sealing area in any part of the lamp between the lens (19) and the body (7), including the convex sectional gasket (10), and by means of this feature, it provides maximum sealing.

6. A front lighting lamp with LED according to claim 1, characterized in that; it contains 30° LED PCB (16) placed in a reverse angled position in order to collect a large part of the light coming out of the LED and transmit it to the road.

7. A front lighting lamp with LED according to claim 1, characterized in that; the one-piece thermal conductive body (7) provides minimum cost with minimum number of parts and maximum centering with minimum predictable misalignment at the product grouping stage.

8. A front lighting lamp with LED according to claim 1, characterized in that; the thermoplastic terminal Insulator (12) is a 100% recyclable elastomer material for maximum sealing in the connector (4) area, thereby providing sealing.

9. A front lighting lamp with LED according to claim 1, characterized in that; the PCB is positioned at an angle of 30° opposite to the parabolic reflector in order to ensure that the 60° light from the LEDs on the PCB (16) reaches the entire area on the surface of the parabolic reflector (15) and illuminates the targeted area at the maximum level. By placing the PCB (11) at an angle with respect to the parabolic reflector (15), all of the light coming out of the LEDs is reflected to the reflector and from there to the road. Thus, maximum lighting efficiency can be achieved by minimizing light loss.

10. A front lighting lamp with LED according to claim 1, characterized in that; it has an anti-condensation protective plug (5) to prevent condensation; due to its structure, by the positioning of an off-axis hole, even if there is snow, dirt, etc. on the lamp, the system is characterized by preventing condensation by continuing the ventilation and by making the ventilation from the side part and by means of its federated structure (6) inside.

11. A front lighting lamp with LED according to claim 1, characterized in that; the position adjustment mechanisms, which consist of more parts, fulfill their task with the position (16) adjustment system, which is shaped in a safe and robust way, consisting of two parts.

12. A front lighting lamp with LED according to claim 1, characterized in that; breaking of the cables due to external factors is also prevented, unlike the state of the art by means of its structure connected to the wireless direct socket on the body (7).
